(19) United States
(12) Patent Application Publication
(10) Pub. No.: US 2011/0058750 A1
(43) Pub. Date: Mar. 10, 2011

(54) METHOD FOR REGISTERING A FIRST IMAGING DATA SET WITH A SECOND IMAGING DATA SET

(76) Inventor: Eike Rietzel, Weiterstadt (DE)

(21) Appl. No.: 12/874,932

(22) Filed: Sep. 2, 2010

(30) Foreign Application Priority Data
Sep. 7, 2009 (DE) 10 2009 040 392.2

(51) Int. Cl. G06K 9/68; G21K 5/00

(52) U.S. Cl. 382/218; 250/491.1

(57) ABSTRACT

A method for registering a first imaging data set with a second imaging data set of an object includes determining range information that describes the range of a beam in the object and determining at least one transformation parameter that describes a registration of the first imaging data set with the second imaging data set. The determination of the at least one transformation parameter is carried out using the determined range information.

This application claims the benefit of DE 10 2009 040 392.2 filed Sep. 7, 2009, which is hereby incorporated by reference.

### BACKGROUND

The present embodiments relate to a method for registering a first imaging data set with a second imaging data set.

Registration methods are used, for example, in medical imaging in order to compare two imaging data sets with one another. Such methods are often applied with regard to patient positioning in the context of beam therapy.

Beam therapy in general and particle therapy specifically are established methods for the treatment of tissue (e.g., tumor diseases). Irradiation methods (e.g., as employed in beam therapy), are, however, also applied in non-therapeutic fields. These non-therapeutic fields include, for example, research work performed in the context of beam therapy on non-living phantoms or bodies and irradiation of materials.

With regard to beam therapy, a beam such as, for example, an X-ray beam, an electron beam or a particle beam consisting of charged particles such as protons, carbon ions or other charged particles is generated and directed onto the object to be irradiated. In order to provide a successful irradiation, the object to be irradiated is positioned as precisely as possible with respect to the beam.

In the context of beam therapy, this positioning may be achieved using therapy planning undertaken on the basis of an imaging data set and a comparison data set recorded in advance of a therapy session. Both data sets are registered with one another, and positional information that can be used to position the patient to be irradiated relative to the beam is determined from this registration. This provides that a subsequent irradiation corresponds precisely to the planned irradiation.

An overview of known registration methods is given, for example, in the publication Maintz, J. B. A. and M. A. Viergever, “A survey of medical image registration,” Medical Image Analysis 2.1, (1998): 1-36.

### SUMMARY AND DESCRIPTION

The present embodiments may obviate one or more of the drawbacks or limitations in the related art. For example, in one embodiment, a method for registering two imaging data sets, which enables precise positioning of an object to be irradiated with respect to a beam is provided.

The preceding and following descriptions of the individual features relate both to the devices and also to the methods of the present embodiments without this being mentioned explicitly in detail in each case; the individual features disclosed may be used in combinations other than those shown.

In one embodiment of a method for registering a first imaging data set with a second imaging data set of an object, range information that describes the range of a beam in the object is determined and at least one transformation parameter that describes a registration of the first imaging data set with the second imaging data set is determined. The determination of the at least one transformation parameter is carried out using the determined range information.

In the case of previously employed registration methods, the registration is based on the image information that is stored in the imaging data sets. In many cases, this may be adequate in order, for example, to position a patient with sufficient accuracy relative to the beam. However, the image information alone may not result in the best possible positioning. The image information alone does not take into consideration the behavior of the beam in the object to be irradiated—at least not to the extent in which the image information is used in conventional registration methods.

If the image information is the sole basis for the registration, the registration may deliver the result that the image data sets are rotated with respect to one another. If a patient positioning operation is performed on the basis of this registration, the patient would also be rotated correspondingly. This rotation may cause dense tissue to be located in the entry channel of a beam, which would substantially influence the range of the beam. In this case, a registration that is based solely on the image information contained in the imaging data sets would lead to an inadequate result.

The behavior of the beam in the object to be irradiated and the resulting range is relevant information that influences the accuracy of an irradiation.

Using the method according to the present embodiments, range information that reflects these circumstances is determined. The range information indicates how strongly a beam penetrates into the object to be irradiated or how strongly a beam is attenuated by the object to be irradiated. This is relevant, in particular, with regard to particle beams because the beam penetrates to a certain depth depending on the energy of the beam and then delivers a major portion of the energy of the beam in a relatively narrowly defined region that is identified by the Bragg peak.

In one embodiment, not only the image information that is stored in the imaging data sets, but also the range information may be used during the determination of the at least one transformation parameter (i.e., during the registration of the two imaging data sets with one another). This results in a registration of the two imaging data sets with one another that better takes into account the needs underlying a beam therapy process (e.g., a particle therapy process).

The range information is determined, for example, from the image information. If, for example, a computer tomography data set is used as the imaging data set, the range information may be determined by adding up, with respect to a beam direction, the HU (Hounsfield units) values of the voxels that lie behind one another in the beam direction.

In one embodiment, range information may be used to weight the image data of the imaging data sets and consequently, contribute to the determination of the transformation parameters, which describes the registration of the imaging data sets with one another. This is advantageous in the situation when a non-linear relationship is given between the values that describe the image information and the range of a beam.

In one embodiment, range information is determined for each of the two data sets. During the registration of the two imaging data sets with one another, the two sets of range information are likewise compared with one another.

These sets of range information may be compared with one another in analog fashion with respect to existing differences (e.g., like image information in the case of conventional registration methods).

In one embodiment, a function that describes a distinction (e.g., a difference) between the two sets of range information is used to determine the at least one transformation parameter.

In one embodiment, range information is determined for only one data set, and the range information for the one data set is used to weight image areas differently in the imaging data sets during the registration. In this manner, the fact that certain image areas are not significant for the registration because a particle beam would not penetrate at all or would penetrate in an attenuated fashion to the corresponding regions in the object may be taken into consideration.

In one embodiment, the sets of range information regarding one imaging data set are not determined for the entire imaging data set but only for a partial area of the imaging data set. In this manner, the fact that a particle beam does not fully penetrate an object to be irradiated but advances only to a certain depth may be taken into consideration. Accordingly, it is sufficient that the sets of range information are determined not for the entire imaging data set but only for a partial area that may, for example, be given by the depth of penetration of the particle beam. The calculation may be performed more quickly in this manner. The sets of range information may, for example, be determined only up to a distal edge, where the distal edge is given by a maximum depth of penetration of the beam.

In one embodiment, a registration mask that identifies those regions of the imaging data set or sets that are to be taken into consideration during the determination of the transformation parameters may be defined. The registration mask may also be determined while taking into consideration the range information.

This takes into consideration the fact that it may be better not to base the registration on the entire imaging data set but only on a partial area. With regard to irradiation of the prostate, for example, it may be advantageous to base the registration only on the prostate and the adjacent region of the bladder or the rectum. Areas in the imaging data sets that have only a slight influence on the position and/or location of the area to be irradiated are prevented from being included in the definition of the transformation parameters. If these areas were to be taken into consideration during the definition of the transformation parameters, this could result in a positioning of the object which is based on the transformation parameters leads to a poorer rather than a better dose application.

In one embodiment, the range information includes a plurality of range information subunits that are each associated with different regions in the imaging data sets, in particular with individual voxels. A range information subunit may be associated, in each case, with different regions or even individual voxels. The range information subunit specifies what influence the respective region or the respective voxel has on the range of a beam.

The range information may be specified, for example, as a water equivalent depth. The water equivalent depth is a known measure that may be used in the context of particle therapy. A voxel may, for example, be characterized by the water equivalent depth. The water equivalent depth of the voxel specifies the depth or distance a particle beam must penetrate in a homogeneous body of water in order to be attenuated to the same extent as by the voxel.

In one embodiment, the range information may be determined with respect to a beam direction. An integral water equivalent depth (e.g., with respect to the beam direction) may be specified as range information, for example.

If, for example, an integral water equivalent depth is associated with a voxel or a region in the object to be irradiated, the integral water equivalent depth specifies the depth/distance a beam would need to penetrate in a homogeneous body of water in order to be attenuated to the same extent as in the object from the point of entry into the object as far as the voxel or the region, including the voxel or the region, respectively.

In one embodiment, if the range information is determined with respect to a beam direction, the range information is re-determined during the determination of the transformation parameters if a beam direction is changed. In this manner, the methods of the present embodiments may be used if the transformation parameters permit a change in the beam direction. This is the case, for example, in the situation where a rotation is permitted as a degree of freedom during the registration.

After the transformation parameters have been determined, the transformation parameters may be used in order to carry out positioning of the object to be irradiated with respect to the beam.

The device for registering a first imaging data set with a second imaging data set according to the present embodiments has a processing unit that is configured in order to execute one of the methods according to the present embodiments. The processing unit may execute one of the methods according to the present embodiments using software, hardware (e.g., a computer processor, a memory), firmware or a combination thereof stored on a non-transitory computer readable storage medium.

### BRIEF DESCRIPTION OF THE DRAWINGS

FIG. 1 shows one embodiment of a particle therapy system,

FIG. 2 shows a schematized representation of an example two-dimensional first imaging data set,

FIG. 3 shows a schematized representation of an example two-dimensional second imaging data set,

FIG. 4 shows a representation of voxel values corresponding to FIG. 2,

FIG. 5 shows a representation of voxel values corresponding to FIG. 3,

FIG. 6 shows a representation of integral sets of range information corresponding to FIG. 2,

FIG. 7 shows a representation of integral sets of range information corresponding to FIG. 3,

FIG. 8 shows a representation of an example registration mask, and

FIG. 9 shows a flow chart of one embodiment of registering a first imaging data set with a second imaging data set of an object to be irradiated.

### DETAILED DESCRIPTION OF THE DRAWINGS

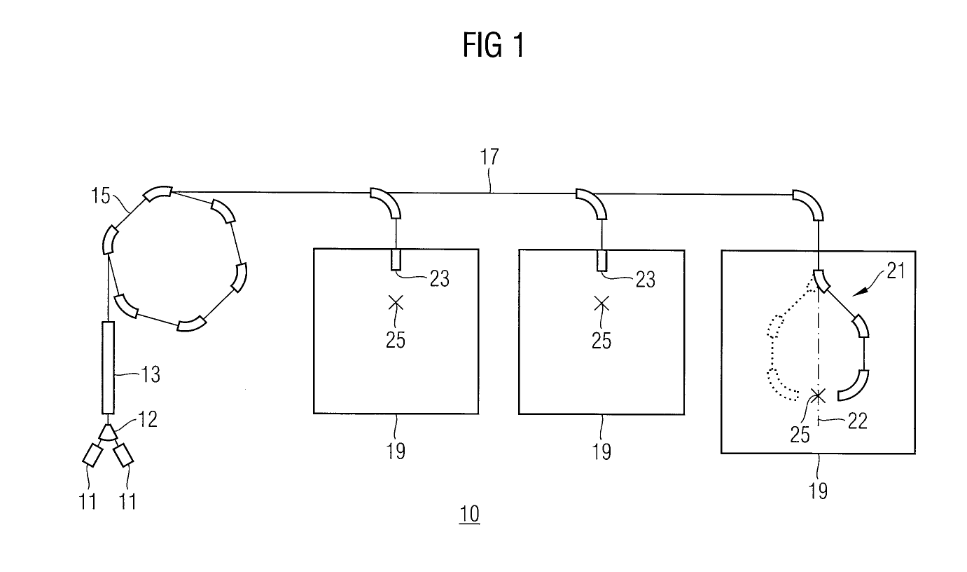

FIG. 1 shows the structure of a particle therapy system 10. In a particle therapy system 10, a body (e.g., tissue having a tumor) may be irradiated using a particle beam.

Ions such as, for example, protons, helium ions, carbon ions or other particle types such as pions may be used as particles. The particles may be generated in a particle source 11. If, as shown in FIG. 1, two particle sources 11 are used to generate two different types of ions, the system may switch between two ion types within a short time interval. For example, a switching magnet 12, which is arranged between the ion sources 11 and a pre-accelerator 13, is used to switch between the two ion types. The particle therapy system 10 may be operated using protons and carbon ions at the same time, for example.

The ions generated by the ion source 11 or one of the ion sources 11 and selected using the switching magnet 12 are accelerated in the pre-accelerator 13 to a first energy level. The pre-accelerator 13 is, for example, a linear accelerator (LINAC). The particles are subsequently fed into an accelerator 15 (e.g., a synchrotron or cyclotron). In the accelerator 15, the particles are accelerated to high energy levels for the irradiation. After the particles leave the accelerator 15, a high-energy beam transport system 17 guides the particle beam to one or more irradiation rooms 19. In an irradiation room 19, the accelerated particles are directed onto a body to be irradiated. This takes place either from a fixed direction (e.g., in “fixed beam” rooms), or from different directions by way of a rotatable gantry 21 operable to move around an axis 22.

In the irradiation room 19, the particle beam exits from a beam outlet 23 and strikes a target volume to be irradiated, which may be situated at the isocenter 25 of an irradiation room.

In order to correctly position a patient in the irradiation room 19, the anatomy of the patient may be re-imaged prior to a planned irradiation session. An imaging data set may be registered with a planning CT in order to determine control parameters therefrom. A patient positioning device appropriately orientates the patient to be irradiated with a treatment beam using the control parameters in order to produce a precise dose application. For this purpose, a device that is designed to execute a method according to the present embodiments may be provided in the particle therapy system.

The basic structure of the particle therapy system 10 illustrated with reference to FIG. 1 is an example of particle therapy systems, but may also differ from that shown.

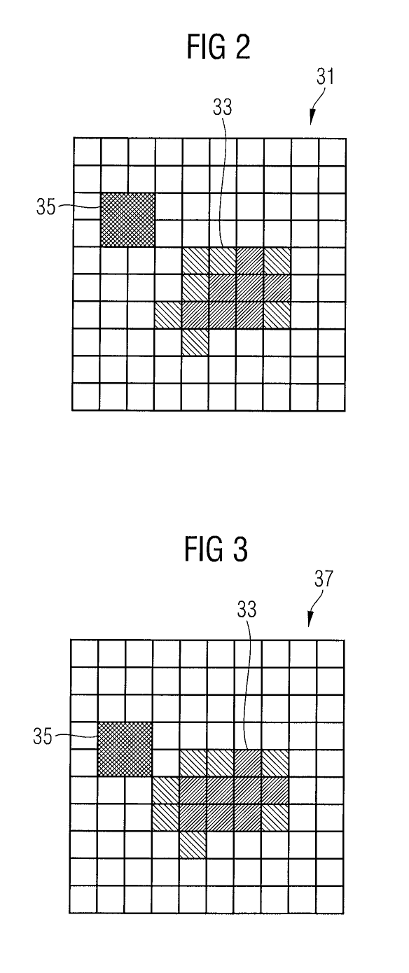

The methods underlying the present embodiments will be described in detail with reference to the following FIGS. 2 to 8. The present embodiments may be used in conjunction with the particle therapy system as illustrated in FIG. 1, but also with other irradiation systems. The present embodiments are not restricted to use in the context of beam therapy.

FIG. 2 is a schematic representation of a first imaging data set 31. A two-dimensional matrix consisting of voxels is illustrated. Imaged in this matrix are a target volume to be irradiated 33 and an area 35 that may influence the irradiation of the target volume, situated in the vicinity of the target volume. FIG. 3 shows the spatial relationships in a second imaging data set 37 that images the target volume 33 and the area 35 situated in the vicinity of the target volume at a later point in time. As shown in FIGS. 2 and 3, the spatial relationships have changed slightly.

The first imaging data set 31 may, for example, form the basis for an irradiation planning, while the second imaging data set 37 may, for example, be captured for positioning a patient. Through a comparison of the first imaging data set 31 with the second imaging data set 37, parameters may be defined. With the aid of the defined parameters, the object to be irradiated 33, 35 may be appropriately positioned in advance of an irradiation. As a result, the irradiation may be performed in compliance with the irradiation planning.

The comparison of the first imaging data set 31 and the second imaging data set 37 takes place in the form of a registration. The transformation parameters that describe the registration may then be used in order to determine the appropriate patient positioning.

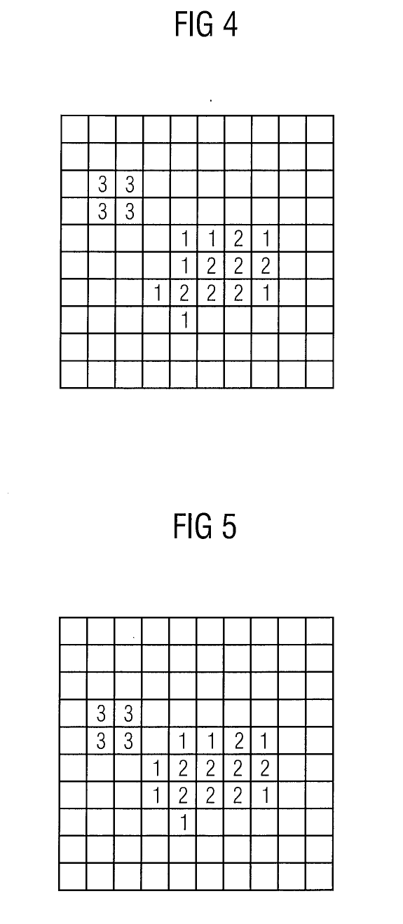

FIG. 4 and FIG. 5 are illustrations in which numerical values are assigned to the voxels. The numerical values represent the gray values of the voxels. For the sake of simplicity and clarity, the numerical values 1, 2, 3 have been chosen here in order to characterize the voxels from FIG. 2 and FIG. 3. Voxels not explicitly assigned numerical values correspond to a numerical value of zero. If a CT data set is used as the imaging data set, the numerical values may, for example, be the HU units that characterize the density of the voxels of the CT data set.

The numerical values from FIG. 4 and FIG. 5 constitute image information that is stored in the imaging data sets 31, 37. As shown in FIGS. 4 and 5, the image information differs slightly between the two imaging data sets 31, 37. In this example, the differences are that the target volume 33 exhibits a slight enlargement and the location of the area 35 in the vicinity of the target volume is shifted downwards by one voxel.

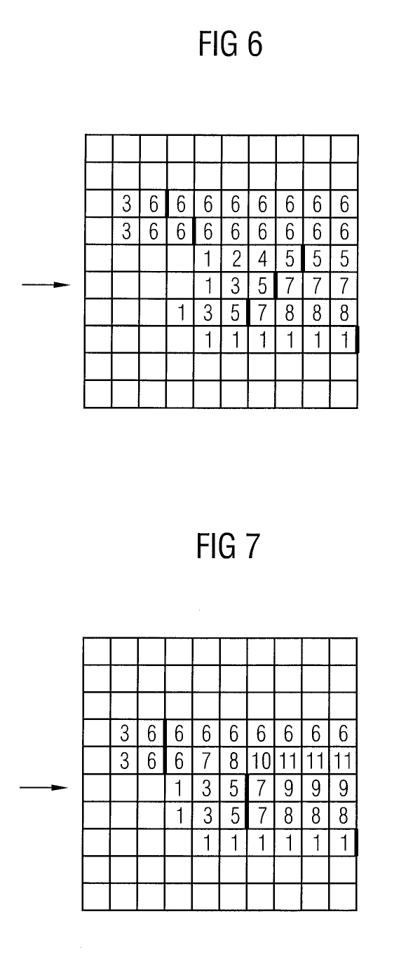

It does not emerge from the image information alone that these slight changes may have a comparatively large effect on the range of a beam. This is made clear with FIG. 6 and FIG. 7.

In FIG. 6 and FIG. 7, sets of range information that have been determined from the image information stored in the imaging data sets (cf. FIG. 4 and FIG. 5) are represented.

For the sake of simplicity, it is assumed here that a water equivalent depth of 1 corresponds to a voxel having a numerical value of 1 in FIG. 4 or FIG. 5 and that a linear relationship exists between the numerical values of the voxels from FIG. 4 and FIG. 5, respectively, and the water equivalent depth. For example, a voxel having a numerical value of 3 has a water equivalent depth of 3 units.

In FIG. 6 and FIG. 7, as a plurality of sets of range information, the integral water equivalent depth with respect to a beam direction from the left (indicated by the arrow) is specified per voxel in each case. Voxels not assigned numerical values have a water equivalent depth of 0.

The integral range information of the first imaging data set 31, imaged in FIG. 6, differs from the integral range information of the second imaging data set 37, imaged in FIG. 7, considerably more than the image information alone.

The integral range information does, however, have a major influence regarding the successful outcome of an irradiation. Thus, if a particle beam were to irradiate the fifth row of the first imaging data set 31 from the left, the particle beam would penetrate considerably further than in the case of an irradiation of the fifth row of the second imaging data set 37. If only the image information in row five is considered (FIG. 2 to FIG. 5), the difference is considerably smaller than the difference between the numerical values in the fifth rows in FIG. 6 and FIG. 7.

If the sets of range information are taken into consideration during a registration of the imaging data sets 31, 37 with one another (e.g., during the determination of the transformation parameters) this has an effect on the result. If, for example, the registration is used in order to define a patient positioning in advance of an irradiation session, the effects that result from the range of a particle beam are taken into consideration in a much better way.

Several voxels are identified in FIG. 6 and FIG. 7 by a thick line at the right-hand edge of the voxel. This thick line identifies, for example, a distal edge that specifies the maximum depth of penetration of a particle beam.

If the maximum energy of the particle beam is, for example, chosen such that the particle beam is only able to penetrate a water equivalent depth of 5 units, a distal edge, as represented in FIG. 6 and FIG. 7, would result. In this case, the sets of range information may be calculated only from the point of entry of the particle beam up to the distal edge because the sets of range information of voxels that lie beyond the distal edge in the beam direction have no further influence on any further penetration of the particle beam.

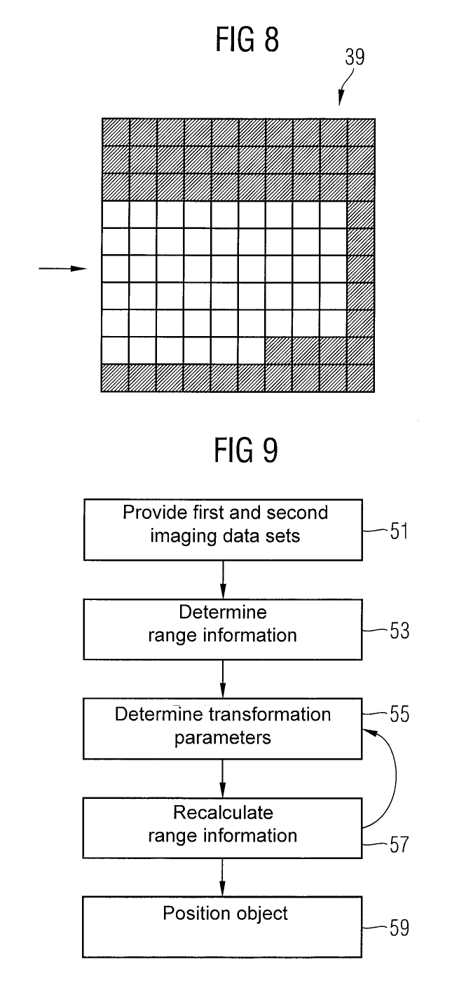

FIG. 8 shows a registration mask 39 that may be used during the determination of the transformation parameters. The registration mask 39 specifies image areas that are to be registered with one another in the imaging data sets 31, 37. With the registration mask, the target volume or the area surrounding the target volume may be specifically taken into consideration. The radiation channel may also be taken into consideration with the registration mask 39. Areas situated at a greater distance from the target volume, which are irrelevant to the location of the target volume and may corrupt the result of the registration, may be excluded using the registration mask 39.

FIG. 9 illustrates a flow chart of registering a first imaging data set with a second imaging data set of an object to be irradiated.

At block 51, imaging data sets that are to be registered with one another are provided. The object to be irradiated, for example, may be imaged in the imaging data sets. At block 53, range information that specifies how far a beam (e.g., a particle beam) penetrates into tissue is determined for each of the two imaging data sets. At block 55, transformation parameters that describe the registration of the two imaging data sets with one another are determined, such that in addition to the sets of image information, the sets of range information for the two imaging data sets are taken into consideration. At block 57, if a change is made to the beam direction of the beam during the determination of the transformation parameters, the sets of range information are re-determined. The transformation parameters may be re-calculated using the changed beam direction. At block 59, control parameters may be determined based on the determined transformation parameters, and the control parameters may be used to position the object to be irradiated.

Detailed explanations will be made in the following as to how sets of range information, which have been determined as described above, may influence the determination of the transformation parameters.

If, for example, the first imaging data set is denoted by F and the second imaging data set by G, the aim is to find a suitable transformation T for the imaging data set F, such that the differences between the transformed imaging data set T(F) and G are minimized, where the range information is taken into consideration during the determination. Minimization may not be finding the absolute minimum. The difference may also, for example, be reduced iteratively and the iteration process terminated as soon as a certain condition is satisfied.

The range information that is associated with one of the image data sets F and G is denoted by R(F) and R(G), respectively, in the following.

Finding the suitable transformation may, for example, be regarded as an optimization problem, where the aim is to minimize (if D measures the inequality) or to maximize (if D measures the equality) D(T(F), G)+a D(T(R(F)), R(G)), where the first summand states the conventional procedure with regard to known registration methods. The second summand now introduces the range information. By using the factor a, the weighting with which the sets of range information are to be taken into consideration may be defined.

As transformation rules T or function for measuring the difference D, known functions T and D for image registration may be used. Conventional registration methods, which are employed in an advantageous manner with regard to beam therapy, may be modified in accordance with the model stated above.

An example of a known registration method, which is carried out in the context of beam therapy for alignment of a portal image with a digitally reconstructed radiograph (DRR), is disclosed in the publication: Hristov, D. H. and B. G. Fallone, “A grey-level image alignment algorithm for registration of portal images and digitally reconstructed radiographs,” Med. Phys. 23.1, (1996): 75-84.

This method may be modified in accordance with the model stated above such that the range information is also taken into consideration during the registration. Since rotations are also permitted with this registration method, the integral sets of range information that are dependent on the beam direction are re-calculated if a different radiation angle is chosen during the optimization.

Similar registration methods for alignment of a portal image with a DRR are also disclosed in the publications: Moseley, J. and P. Munro, “A semiautomatic method for registration of portal images,” Med. Phys. 21.4, (1994):551-58; and Dong, L. and A. L. Boyer, “A portal image alignment and patient setup verification procedure using moments and correlation techniques,” Phys. Med. Biol. 41, (1996): 687-723.

Even if the registration methods stated above relate to an alignment of a portal image with a DRR, such a method may also be applied to other imaging data sets. The methods may be generalized to three-dimensional or four-dimensional imaging data sets. A portal image may not be compared with a DRR. For example, a cone beam CT data set that has been recorded during patient positioning may be compared with a planning CT.

An overview of different registration methods is given, for example, by the publication Maintz, J. B. A. and M. A. Viergever, “A survey of medical image registration,” Medical Image Analysis 2.1, (1998): 1-36.

A test as to whether the modification of a known registration method is also suitable, for example, for patient positioning (e.g., whether the weighting factor a has been chosen appropriately) may be performed by testing the method on one or more virtual situations (e.g., planning CT or image data set for positioning a virtual patient), positioning the virtual patient “virtually” in accordance with the determined transformation rule, and simulating the irradiation on the basis of the virtual positioning. The “virtually” applied irradiation may be compared with a predefined target dose. Whether the modification of a known registration, to the effect that the range information is also taken into consideration, would also lead to an improvement in dose deposition may be ascertained.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for registering a first imaging data set with a second imaging data set of an object, the method comprising:
determining range information that describes the range of a beam in the object; and
determining a transformation parameter that describes a registration of the first imaging data set with the second imaging data set,
wherein determining the transformation parameter comprises using the determined range information.

2. The method as claimed in claim 1, wherein determining the range information comprises determining range information for each of the two imaging data sets.

3. The method as claimed in claim 2, wherein determining the transformation parameter comprises using a function that describes a difference between the two sets of range information.

4. The method as claimed in claims 1, wherein determining the range information comprises determining the range information only for a partial area of the first imaging data set and the second imaging data set.

5. The method as claimed in claim 1, wherein determining the range information comprises determining the range information only up to a distal edge,
wherein the distal edge is a maximum depth of penetration of the beam.

6. The method as claimed in claim 1, further comprising defining a registration mask,
wherein the registration mask identifies the areas that are taken into consideration during the determination of the transformation parameters.

7. The method as claimed in claim 1, wherein the range information comprises a plurality of range information subunits that are each associated with different regions in the first imaging data set, the second imaging data set, or the first imaging data set and the second imaging data set.

8. The method as claimed in claim 1, wherein a water equivalent depth is used as the range information.

9. The method as claimed in claims 1, wherein the range information is determined with respect to a beam direction.

10. The method as claimed in claim 9, wherein an integral water equivalent depth is used as the range information.

11. The method as claimed in claim 9, further comprising re-determining the range information during the determination of the transformation parameters if a beam direction is changed.

12. A method for positioning an object to be irradiated relative to a beam, the method comprising:
determining range information that describes the range of the beam in the object;
determining a transformation parameter that describes a registration of a first imaging data set with a second imaging data set; and
positioning the object as a function of the transformation parameter,
wherein determining the transformation parameter comprises using the determined range information.

13. An apparatus for registering a first imaging data set with a second imaging data set, the apparatus comprising a processing unit configured to:
determine range information that describes the range of a beam in an object to be irradiated;
determine a transformation parameter that describes a registration of the first imaging data set with the second imaging data set,
wherein determining the transformation parameter comprises using the determined range information.

14. The method as claimed in claims 2, wherein determining the range information comprises determining the range information only for a partial area of the first imaging data set and the second imaging data set.

15. The method as claimed in claim 2, wherein determining the range information comprises determining the range information only up to a distal edge,
wherein the distal edge is a maximum depth of penetration of the beam.

16. The method as claimed in claim 3, further comprising defining a registration mask,
wherein the registration mask identifies the areas that are taken into consideration during the determination of the transformation parameters.

17. The method as claimed in claim 7, wherein the different regions are individual voxels.

18. The method as claimed in claim 12, wherein determining the range information comprises determining range information for each of the two imaging data sets.

19. The method as claimed in claim 12, further comprising defining a registration mask,
wherein the registration mask identifies the areas that are taken into consideration during the determination of the transformation parameters.

20. The apparatus as claimed in claim 13, wherein the processing unit is configured to determine range information for the first imaging data set and the second imaging data set.
